(19) United States
(12) Patent Application Publication
(10) Pub. No.: US 2010/0078184 A1
(43) Pub. Date: Apr. 1, 2010

(54) FIXED RESIDENTIAL FIRE SUPPRESSION SYSTEM

(76) Inventor: Michael M. Pellittiere, II, Livonia, NY (US)

Correspondence Address: LAW OFFICE OF TRACY P. JONG, 2775 BUFFALO ROAD, SUITE 3, ROCHESTER, NY, 14624, US

(21) Appl. No.: 12/240,811

(22) Filed: Sep. 29, 2008

(51) Int. Cl. A62C 35/00

(52) U.S. Cl. 169/51

(57) ABSTRACT

A fixed residential fire suppression system contained in a wall mounted cabinet and having a flat lying fire resistant hose situated on the drop down cabinet door housing in a folded configuration; a manual discharge fire suppression foam delivery system with a fire suppression foam applicator unit, a foam nozzle with a smooth inner bore on the discharge tip, and a means of connecting to a residential water supply with a quarter turn valve such that the foam nozzle emits in combination water from the residential water supply and a fire suppression foam from the foam applicator unit.

### BACKGROUND OF THE INVENTION

1. Field of the Invention

This invention relates generally to fire suppression devices and more particularly to fixed residential fire suppression systems using fire suppression foam.

2. Description of Related Art

Fixed residential fire suppression systems have gained popularity as a substitute for or an addition to portable fire extinguishers. They take many shapes and forms, and offer a variety of features. While these prior art fire suppression systems are presumably adequate for their intended purposes, none of these prior art devices are configured adequately for use in residential homes with relatively low water pressure in terms of fire suppression. Additionally, none of the prior art residential systems can be fully integrated with fire detection and home monitoring systems.

Prior art fire suppression apparatus have a number of drawbacks. Many use inferior grade hoses that are subject to deterioration and not heat resistant for fire suppression use. Many use hoses with diameters that are inadequate for the water pressure and flow rate of domestic water systems. Many use adjustable nozzles that interfere with water flow and produce irregular flow distribution patterns, decreased water pressure and decreased flow rate. Many use rolled hoses which require a significant amount of room to store, and require cabinets with depths that render them impractical for residential wall installation. The rolled hoses are also difficult to unfold and require that the entire hose length be unfolded prior to use, taking precious time during an emergency. Some have valves that are hidden or difficult to operate in an emergency situation. None use foam surfactants to enhance the fire suppression power of the limited water flow rate and pressure available in domestic water systems.

Thus, it is desirable to provide a fixed residential fire suppression system that improves upon the prior art and eliminates one or more of its shortcomings and limitations.

### SUMMARY OF THE INVENTION

In accordance with the present invention, there is provided a fixed residential fire suppression system with a cabinet housing configured to be mounted in a wall. Stored inside the cabinet housing is a heat resistant hose situated in a folded or “flaked” configuration and removably secured by a mechanical fastener. There is also stored inside a manual discharge fire suppression foam delivery system comprising a fire suppression foam applicator unit, a foam nozzle and a means for connection to a residential water supply. The heat resistant hose is operably connected to the means for connection to the residential plumbing system and the foam applicator unit is operably connected to and situated between the heat resistant flat lying hose and the foam nozzle. The foam nozzle emits in combination water from the residential water supply and fire suppression foam from the foam applicator unit.

There is also disclosed a fixed residential fire suppression system with a cabinet housing having a drop down door (also mounted in a wall). The heat resistant hose is a flat-lying hose with a mechanical memory and a diameter of 0.75 inch. The hose is situated on the drop down door of the cabinet in a folded or “flaked” configuration and removably secured therein by a quick-releasing strap harness with a hook and loop fastener. There is also a manual whistle situated in the cabinet housing and a manual discharge fire suppression foam delivery system as described in the preceding embodiment.

In another embodiment, there is disclosed a fixed residential fire suppression system where the means for connection to the residential water system is a standpipe connected to a residential plumbing system with a one quarter turn valve. The foam nozzle emits in combination water from the residential plumbing system and a fire suppression foam concentrate from the foam applicator unit having a foam concentrate selected from the group consisting of a protein based fire suppression foam concentrate, an aqueous film forming fire suppression foam concentrate, and an alcohol resistant aqueous film forming fire suppression foam concentrate.

In various other embodiments, the fixed residential fire suppression system is integrated with home security or fire detection systems and/or has optional features such as a fail safe lock, remote lock actuation capability and “open door” alarms.

It is an object of the present invention to provide a fixed fire suppression system for residential homes that provides an enhancement to the fire suppression capabilities of the residential water supply, especially when there is low water pressure.

It is yet another object of the present invention to provide a fire suppression system that may be used with residential water supplies of varying pressures and configurations.

It is yet another object of the present invention to provide a fire suppression system that provides a hose that is not subject to dry rot or other deterioration during storage or flow impeding kinks during use.

It is yet another object of the present invention to provide a fire suppression system that may be integrated with various fire detection and monitoring systems.

It is yet another object of the present invention to provide a fire suppression system with a foam valve that does not reduce the water pressure and/or flow rate at its discharge point.

It is yet another object of the present invention to provide a fire suppression system that reduces the time and steps it takes a user to engage the fire suppression components for firefighting.

It is yet another object of the present invention to provide a fixed fire suppression system that is durable and reliable.

It is yet another object of this invention to provide a fixed residential fire suppression system that is economical from the viewpoint of the manufacturer and consumer, is susceptible of low manufacturing costs with regard to labor and materials, and which accordingly is then susceptible of low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### BRIEF DESCRIPTION OF THE DRAWINGS

The invention will be described by reference to the specification and the drawings, in which like numerals refer to like elements, and wherein:

FIG. 1 is a perspective view of a fixed residential fire suppression system with the cabinet closed;

FIG. 2 is a perspective view of a fixed residential fire suppression system with the cabinet open; and

FIG. 3 is a partial sectional view of a foam applicator unit of the fixed residential fire suppression system.

The drawings are not to scale, in fact, some aspects have been emphasized for a better illustration and understanding of the written description.

### DETAILED DESCRIPTION OF A PREFERRED EMBODIMENT

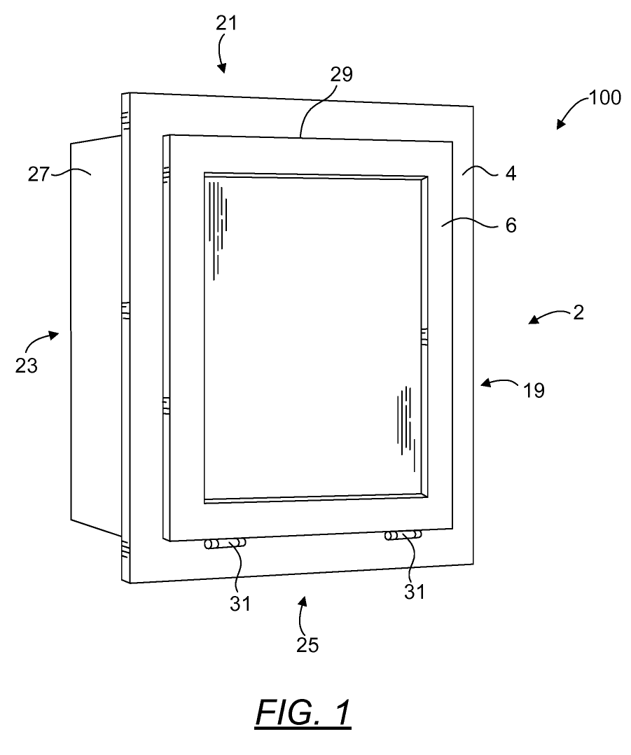

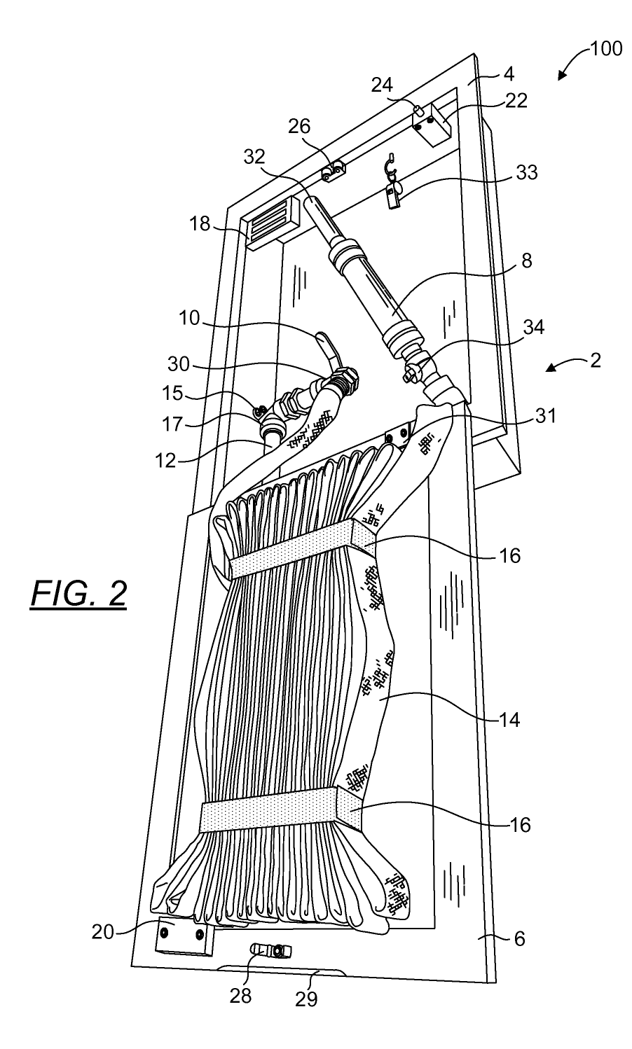

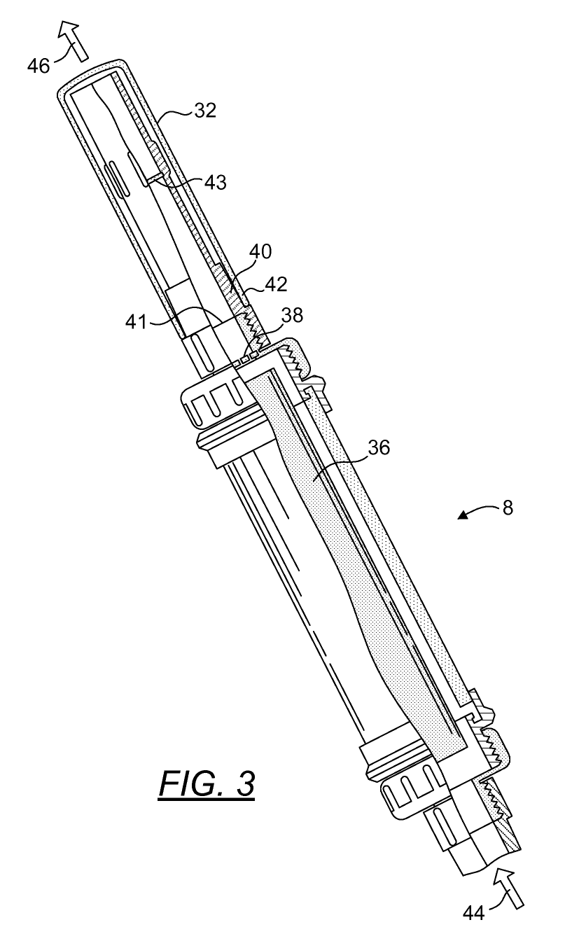

The present invention comprises a fixed residential fire suppression system 100 that is permanently mounted in a wall. For both aesthetic and functional reasons, the system is contained in a cabinet style housing. FIG. 1 is a perspective view of a fixed residential fire suppression system 100 with the cabinet closed and FIG. 2 is a perspective view of a fixed residential fire suppression system 100 with the cabinet open. FIG. 3 is a partial sectional view of a foam applicator unit of the fixed residential fire suppression system. Except when in use, the cabinet door 6 is held closed by spring closing hinges 31 and/or by the engaging of a latch mechanism 26, 28 and/or a locking device 18, 20. In the embodiment depicted, opening of the cabinet door 6 is facilitated by a recess 29 in the top 21 of the door that allows a user to insert fingers to grasp the cabinet door 6. Alternately, a handle, pull strap, magnetic lease, or other commonly used means or hardware for opening the door may be provided. The lack of protruding hardware from the door face is commonly found aesthetically pleasing.

Referring to FIG. 2, inside the cabinet housing 2 is contained a heat resistant hose 14 that is removably secured therein by one or more mechanical fasteners 16. There is also a manual discharge fire suppression foam delivery system comprising a fire suppression foam applicator unit 8, a foam nozzle 32 and a means for connection to a residential water supply 12. The heat resistant fire hose 14 is preferably folded back and forth with its folded layers vertically stacked and secured on the interior surface of the cabinet door 6 and with the foam nozzle (not visible in this view beneath cap 32) arranged uppermost in the interior compartment of the cabinet housing 2. The heat resistant hose 14 is operably connected to the means for connection to the residential plumbing system 12. The foam applicator unit 8 is operably connected to and situated between the heat resistant flat lying hose 12 and the foam nozzle 40. The foam nozzle (see 40 of FIG. 3) emits a combination of water from the residential water supply 12 and a fire suppression foam concentrate from the foam applicator unit 8 to provide a general foam blanket of fire suppression coverage. The foam nozzle inducts air to the foam concentrate -water combination to create foam or foamy water effluent. Fittings of the fire suppression system 100 are preferably made from brass and therefore corrosion resistant.

In use, the cabinet housing 2 is mounted with screws or other appropriate mounting means, preferably between studs in a wall. A water supply line 12 from the residential plumbing system is brought into and through the bottom 25 of the cabinet housing 2. Attached to the terminus of the water supply line standpipe is the quarter turn water control valve 10, itself, in turn, attached to the heat resistant hose 14. At the time of need, the cabinet door 6 is opened, and the foam applicator unit 8 is removed from the cabinet housing 2. The heat resistant hose 14 is operably attached to the foam applicator unit 8 such that the pulling force exerted on the mechanical fasteners 16 by the user pulling the foam applicator unit 8 into position for use and the filling of the hose 14 causes the hose 14 to be pulled from the cabinet door 6 as it begins straightening out. Water from the water supply line 1 2 passes through the first quarter turn control valve 10 and into the hose 14, expanding and straightening the hose as it passes through the foam applicator unit 8 over and around the internal foam concentrate cartridge to the foam nozzle 40.

The fire suppression foam delivery system features a flow-through design that will operate on any available residential water pressure. As will be apparent, the higher the pressure, the greater the reach of the foam-water stream. Optimum stream distance is realized where the residential water supply exerts a minimum 30 psi. Optimally, water pressures between 35 psi and 85 psi are supplied to the fixed fire suppression system from the residential water supply.

The fixed residential fire suppression system overcomes one of the primary disadvantages of residential water supplies—the lack of adequate water pressure and volume for effective fire suppression. The mixture of a foam fire suppressant (surfactant or wetting agent) concentrate with the water enhances the fire suppressing power of the water. Additionally, carefully configured hose diameters and foam nozzle conformation optimize the fire suppression effectiveness of the present invention. Thus, any user can effectively fight a fire in the home with the fire suppression capability similar to professional firefighting equipment. The most common types of home fires (Class A fires) can be effectively suppressed.

The fixed residential fire suppression system has advantages not offered by typical fire extinguishers. First, the present invention offers unlimited water supply while a fire extinguisher has a small fire suppression capacity. Additionally, the present invention offers a home unit that may be fully integrated with various alarms, home monitoring systems and fire detection systems.

The cabinet housing 2 is preferably constructed of wood but may also be constructed of other materials commonly used in residential construction. For example, a sheet metal housing similar to that used for electric breaker boxes may be suitably adapted. High strength and heat resistant plastics and polymers may also be used. The cabinet housing 2 is preferably mounted such that the box portion 27 is fully seated within the wall and its peripheral edge is flush with the wall. The cabinet door 6 may be similarly seated within and flush with the wall's exterior surface, however, it is anticipated that many installations will have the cabinet door 6 protruding from the surface of the wall. In the embodiment depicted, there is provided a frame 4 that peripherally surrounds and extends from the opening of the box portion. This frame 4 provides a sturdy mounting flange, provides an aesthetically pleasing appearance and greater range of motion for the hinges 31 to operate and the cabinet door 6 to open without hindrance (as might be the case if the door were flush mounted with the wall).

The cabinet housing 2 may be recessed into the wall of any location in which a fire is likely to occur in the household (e.g., kitchen, workshop, garage or sleeping areas). Water from the residential plumbing system is led into the cabinet housing 2 by means of a standpipe 12 or similar means of connecting to the residential plumbing system which preferably connects through an elbow connection 17 mounted in the cabinet by means of a bracket 15 to an on/off quarter turn valve 10. In a preferred embodiment, the means for connection to the residential plumbing system is a hallway connection since it will provide centralized coverage.

The cabinet housing 2 may take any size or shape adequate to house the components of the fire suppression system. In one aspect, the cabinet housing 2 and cabinet door 6 have a substantially rectangular shape. This shape facilitates both easy manufacturing of the cabinet housing 2 as well as easy mounting by the installer. The cabinet housing 2 has a top 21, a bottom 25, a back, and both a first side 23 and a second side 19. In addition the cabinet housing 2 is equipped with a cabinet door 6 hingeably attached to the bottom 25 by hinges 31. In one aspect, spring activated type hinges are used such that the cabinet door 6 will remain in an open position when fully opened but will force the cabinet door 6 closed in any position less than fully open.

The open side of the box portion is covered and concealed by a vertically swingable front cabinet door 6, hinged to the bottom 25 of the cabinet housing 2 so that the cabinet door 6 may swing downwardly below the cabinet housing 2 to a vertical position substantially against or parallel with the wall on which the cabinet housing 2 is mounted. While the cabinet door 6 may be suitably affixed on any of the four sides 19, 21, 23, 25 of the rectangular shaped box portion 27, it is preferably affixed to the bottom side 25 to form a drop down door.

This configuration is advantageous in that the cabinet door 6 will not interfere with nearby wall hangings, furniture, light fixtures and the like. Similarly, other objects near the door are less likely to interfere with opening of the cabinet door 6. It also serves to dispose the hose 14 at a lower position than the water supply 12 during use. The cabinet door 6, itself may also be equipped with a pull-type handle (not depicted). The corresponding latch portion 26 ( in this case a roller catch) is mounted in a corresponding position on the inside of the top side 21 of the cabinet so that the latch 28 and the corresponding latch portion 26 engage when the cabinet door 6 is in a closed position (as depicted in FIG. 1).

One of the features of the present invention that improves upon the prior art is incorporation of a heat resistant fire hose 14 that is suitable for fire suppression purposes due to its ability to withstand the intense heat of a fire rather than the garden hose or general utility hose found in many prior art units. The fire hose 14 is formed of heat resistant materials with a mechanical memory that automatically returns to a “flat” shape when not filled with water under pressure. While the hose is flat while not in use, it inflates to a rounded configuration during use when water flows through it. The mechanical memory allows the hose to return to its resting (flat) configuration after use.

The heat resistant hose 14 is of a suitable length to reach from the cabinet door 6 to the area desired to be protected that is the furthest from the cabinet housing 2, and may be as long as 50 or 100 feet in length. Any desired hose 14 length may be used. Preferably, the hose 14 comprises a high standard fire rated hose such as a forestry firefighting hose. By way of example, but not limitation, a heat resistant hose 14 may comprise a “forestry fire hose” sold under the trade name ECONOFLO and part number 2475 distributed by Niedner in Norton, Vt. and Coaticook, Quebec, Canada. These high standard fire rated hoses are often made of an extruded elastomeric material, usually a polyester material that is age resistant, to minimize or prevent dry rot, kinking or deformation during use/storage and other types of degradation commonly associated with typical plastic or cotton hoses.

Another important feature of the present invention is incorporation of a hose 14 that can be disposed in a folded or “flaked” configuration (see FIG. 2) during storage. While other hoses and folding methods may be adapted to the present invention, Applicant believes that a hose that lies flat during storage provides at least three advantages. First, the hose will not be disposed to deformation and kinks from bends created during storage of the hose for long periods. Second, the folded or “flaked” configuration depicted in FIG. 1 allows the hose to dispense easily without having to be unrolled by the user or otherwise subjected to a time consuming unfolding process during an emergency fire situation. Thirdly, the folded configuration allows storage of the hose for long periods in a compact manner in a small space without compromising utility or function of the hose. This allows the cabinet depth to be narrow enough that the cabinet housing can be effectively installed within the depth of a typical residential wall.

Preferably, the hose 14 has a diameter of 0.75 inch. This is important because typical residential water supplies can fully inflate a hose 14 of this diameter with sufficient water volume during use. This decreases friction in the hose 14, does not induce a water pressure decrease, and optimizes the fire suppression capability of the water and/or fire suppression foam. In some cases, fire hoses with a diameter of 0.5 to 1.5 inches may alternatively be used with appropriate foam nozzle and foam applicator unit sizes.

The hose 14 is removably secured in the cabinet housing 2 by a mechanical fastener 16 such as a clamp, a quick-release bracket, strap harness, tie, hook and loop, snap, and combinations thereof. Any mechanical fastener 16 that allows quick and instinctive disengagement by a user during an emergency may be suitably adapted. In a preferred embodiment depicted in FIG. 2, the mechanical fastener 16 is a flexible strap harness looped about the stacked hose 14 with the strap harness releasably anchoring the hose 14 on the cabinet door 6 by hook and loop or snap fasteners at the side portions thereof. Additional tension on the strap harness 16 will separate the fasteners so that the fire hose 14 may be pulled forwardly from the cabinet door 6.

The strap harness 16 secures the hose 14 in the cabinet 2 or on the interior of the cabinet door 6. The hook and loop fastener (e.g. VELCRO) is quick-releasing in that it will break away when a pulling force is exerted by a user pulling the hose 14 away from the cabinet for use. Thus, the step of removing the hose 14 for use is simplified and valuable time is saved during an emergency. This configuration also allows the hose 14 to be easily used by someone wearing firefighting gloves, having compromised manual dexterity, having diminished visibility due to smoke or dark, or the like.

Locating the hose 14 on the interior of the cabinet door 6 allows it to be used without interference from other components of the system in the cabinet housing 2 and maximizes the length of hose 14 available for use, however, the invention is not so limited. Other locations for storing the hose 14 in the cabinet housing 2 may be used.

Commonly, the residential water supply will be a standpipe 12 connected to a residential plumbing system. In a preferred embodiment, the residential water supply has two one quarter turn valves 10, 34, one controlling water flow into the hose 10 to the hose 14 and a second one 34 downstream from the hose but prior to the foam applicator unit 8 such that it provides local control of water supply while fire fighting. The preferred embodiment of the invention shows a water supply line standpipe 12 coming from the standard domestic water supply system and entering the cabinet housing 2 through the bottom 25. The water supply line may be brought in from above 21 the cabinet 2 or from any side 19, 23 of the cabinet housing 2. On the interior of the cabinet housing 2 and attached to the terminus of the water supply line standpipe 12 is a water control valve 10 mounted in the interior of the cabinet housing 2. Such water control valve 10 can be either of a typical counterclockwise opening valve or a single-lever type valve. A quarter turn valve is preferred.

As will be apparent, other connections to a residential water supply 12 may be suitably used without departing from the spirit of the invention disclosed. In one aspect of this embodiment, a quick-released on/off-type valve, preferably a quarter turn valve, is provided on the outer end of the hose affixed to the foam applicator unit 34.

The fire suppression is accomplished by a manual discharge fire suppression foam delivery system situated in the cabinet housing 2. For the fire to sustain combustion, you need the following factors: Fuel, oxygen, heat and chain reaction. If any of these are eliminated, the fire will go out. The functions of the foam are to cut off the oxygen supply, act as a vapor seal over the fuel and at the same time cool the area due to the water content in the foam which greatly reduces the risk of re-ignition.

There is provided a fire suppression foam applicator unit 8 with a foam nozzle 40 that is operably connected to the residential water supply 12. The foam nozzle 40 emits a combination of water from the residential water supply 12 and a fire suppression foam concentrate from the foam applicator unit 8. In some aspects, it is also combined with air to produce the foamy water. Preferably, the foam cartridge 8 emits class A or class B fire suppression foam concentrate. As known by those skilled in the art, fires are classified according to fire classes that categorize by types of fuel supply and presence or absence of electrical energy. The type of fire prescribes what type of fire suppression agent will be effective. Class A fires are those fueled by materials that, when they burn, leave a residue in the form of ash, such as paper, wood, cloth, rubber, and certain plastics. Any given fire can fall into more than one class. For example, a fire that involves both burning paper and kitchen grease would be a Class AB fire.

By way of illustration, a foam applicator unit 8 from FAST FOAM (www.fast-foam.com) may be used. FAST FOAM is a Class-A foam that facilitates wetting of Class-A fuels (wooden structures, shrubs, trees, and the like) by lowering the surface tension of the water and assisting with the water's saturation of the fuels. The resulting “foamy water” aids in fire suppression by preventing ignition. By way of further illustration, one may use SCOTTY FOAM FAST ¾″ Foam Applicator 4010-3, a foam surfactant/wetting agent 36. In this foam applicator unit, the foam surfactant/wetting agent 36 is contained in a 12″ foam applicator unit 8 having a cartridge restraint 38 at the juncture between the discharge nozzle 40 and the foam storage supply in the foam applicator unit 8. Water from the hose 14 connected to the residential water supply 12 enters the cartridge 44, mixes with the foam surfactant/wetting agent, then exits through the air inducting discharge nozzle where it is mixed with air to create a foamy water effluent. Other fire suppression foams may be used, such as but not limited to, protein based fire suppression foam concentrates (e.g. fluoroprotein), aqueous film forming fire suppression foam concentrates, and alcohol resistant aqueous film forming fire suppression foam concentrates.

The foam nozzle 40 is an important feature of the present invention. The discharge tip has a smooth inner bore measuring about one-half the diameter as the diameter of the fire resistant hose 14 so as to provide adequate application reach and to insure proper mixing of the foam product. Preferably, the bore has an inner diameter of 0.3-0.4 inch. A screen 43 and a cartridge restraint 38 are provided. The corresponding diameter of the hose 14 and foam nozzle 40 is important because maximum water volume passes through uninhibited and optimum fire suppression is achieved. This provides adequate application reach and flow controller 41 insures proper mixing of the foam product concentrate with the water and air to produce the foamy water effluent. Preferably, the foam nozzle comprises a non-adjustable air-aspirating (also commonly referred to as aspirating or air inducting) foam nozzle. By using a nonadjustable nozzle, there are no internal parts to decrease flow rate or adversely affect mixture ratio. The smooth bore without adjusting components mitigates pressure drop due to these devices and provides optimal discharge flow and flow rate. Preferably, the foam nozzle comprises an air inducting foam nozzle. In a preferred embodiment, the foam nozzle 40 comprises a 3 gpm air-aspirating foam nozzle.

The foam applicator unit 8 further comprises a quick release cap 32 disposed over the foam nozzle 40 to prevent drying of the foam concentrate in the foam applicator unit 8 during long term storage. The cap 32 also prevents infiltration of insects and other contaminants. The quick release cap 32 detaches 46 under water pressure from a discharge of the foam nozzle 40. Thus, the cap 32 needs to snug at 42, but not so tight that it will not release upon commencement of water flow through the foam nozzle 40. In such manner, the cap 32 will be released automatically even when a user fails to remove it prior to activating the foam applicator unit 8. Preferably, the quick release cap 32 will be formed of a translucent polymeric material such that a user can visually identify that the cap 32 is a separate component to be removed from the nozzle 40 prior to discharging the fire suppression foam.

Optionally and additionally, the fixed residential fire suppression system 100 may contain a manual whistle 33, an interior light (not depicted), a flashlight (not depicted), an emergency warning horn (not depicted), heat resistant gloves (not depicted) and/or other fire safety equipment situated in the cabinet housing 2.

In one aspect, the residential fire suppression system is integrated with a home monitoring or fire detection system. The monitoring system may be local or remote monitoring type system. The electronic connections to such systems are well known in the art as many such local monitoring systems and remote monitoring systems are known and commercially available. These monitoring systems may be limited to monitoring for fires (heat or smoke) but in most cases also monitor for home security (break-ins, theft and the like). Some local systems may contain portable alarm devices worn by a user or placed in various locations about the home. These portable alarm devices can be manually activated to cause a heightened alert condition of the system. These are known and commonly used by elderly or disabled homeowners.

These monitoring systems (local and remote) generally have a monitoring status condition where the system is continuously monitoring for predetermined conditions to occur. The systems also have a heightened alert condition that is activated when one or more of the predetermined conditions is detected. To facilitate integration with such home security and fire detection systems, the cabinet contains a switch 24 operably connected to the local or remote monitoring system. In one configuration, opening of the cabinet door 6 activates the switch and initiates an alarm signal adapted for reception by the local or remote monitoring system, thereby changing the monitoring system from a monitoring mode to a heightened alert condition. In one configuration, the inverse is also true whereby the cabinet door opens upon the trigger of a fire alarm.

In another configuration, the switch 24 is operably connected to a self standing audible alarm 22. Opening of the cabinet door 6 activates the switch 24 and initiates a signal to the self standing audible alarm 22 to cause an audible alarm to sound.

In one configuration, the cabinet contains a locking device 18 operably connected to the cabinet door 6 with a corresponding locking portion 20 and also operably connected to a fire detection system having the previously described heightened alert condition and monitoring status condition. The locking device 18, 20 is disposed in the locked position or condition when the fire detection system is in the monitoring status condition. When the fire detection system is in the heightened alert condition, the monitoring system initiates a signal that is received by the locking device 18, 20 and causes the locking device 18, 20 to move to the unlocked position or condition such that the cabinet door 6 can be accessed and opened.

In one configuration, the fixed residential fire suppression system also has a local override device operably connected to the locking device. Activation of the local override device initiates a signal to the locking device 18, 20 and causes the locking device 18, 20 to move to the unlocked position or condition and the door of the cabinet housing 2 to unlock and provide access to the interior of the cabinet.

In one configuration, the fixed locking device is “fail safe.” Preferably, in this aspect, the locking device 18, 20 comprises an electromagnetic device with an electromagnet and an armature plate. When electric power is supplied to the locking device/fire suppression system, it is in the locked position or condition. However, when electric power is no longer supplied to the locking device 18, 20 and/or fire suppression system, it deactivates the locking device 18, 20 and causes it to move to an unlocked position or condition.

In one configuration, the fixed residential fire suppression system has a flow switch operably connected to the residential water supply and also operably connected to fire detection system. The flow switch has both an open and a closed position. The fire detection system has a heightened alert condition and a monitoring status condition. The flow switch is disposed in the closed position in the monitoring status condition. However, when water passes through the flow switch, it goes into the open position and initiates a signal that is received by the fire detection system to cause it to change to heightened alert condition.

What has been disclosed is a fixed residential fire suppression system using fire suppression foam, the cabinet of which can be mounted into a wall. Obviously, many modifications and variations of the invention are possible in light of the above teachings. It is therefore understood that the invention is not to be limited by the single embodiment shown in the drawings and described in the description, which are given by way of example and not of limitation, but only in accordance with the scope of the appended claims.

I claim:

1. A fixed residential fire suppression system comprising a cabinet housing configured to be mounted in a wall, a heat resistant flat laying fire hose situated in the cabinet housing in a folded configuration and removably secured therein by a mechanical fastener, and a manual discharge fire suppression foam delivery system situated in the cabinet housing and comprising a fire suppression foam applicator unit, a foam nozzle and a means for connection to residential water supply, wherein the heat resistant hose is operably connected to the means for connection to the residential plumbing system, wherein the foam applicator unit is operably connected to and situated between the heat resistant flat lying hose and the foam nozzle, and wherein the foam nozzle emits in combination water from the residential water supply and a fire suppression foam from the foam applicator unit.

2. The fixed residential fire suppression system of claim 1, wherein the heat resistant hose comprises a forestry firefighting hose.

3. The fixed residential fire suppression system of claim 1, wherein the heat resistant hose comprises a polyester fire hose with a mechanical memory, having a diameter of 0.75 inch, and configured to be disposed in a folded configuration during storage.

4. The fixed residential fire suppression system of claim 1, wherein the means for connection to the water supply comprises a standpipe adapted to a residential plumbing system.

5. The fixed residential fire suppression system of claim 1, wherein the mechanical fastener is a mechanical fastener selected from the group consisting of a belt, quick-release bracket, strap harness, clamp, tie, hook and loop fastening device, snap, and combinations thereof.

6. The fixed residential fire suppression system of claim 1, further comprising a switch situated in the cabinet housing and operably connected to a local monitoring system wherein opening of a door of the cabinet housing activates the switch and initiates an alarm signal adapted for reception by the local monitoring system, thereby changing the local monitoring system from a monitoring status condition to a heightened alert condition.

7. The fixed residential fire suppression system of claim 1, further comprising a switch situated in the cabinet housing and operably connected to a self standing audible alarm wherein opening of a door of the cabinet housing activates the switch and initiates a signal adapted for reception by the audible alarm to cause an audible alarm to sound.

8. The fixed residential fire suppression system of claim 1, further comprising a switch situated in the cabinet housing and operably connected to a remote monitoring system wherein opening a door of the cabinet housing activates the switch and initiates a signal adapted for reception by the remote monitoring system thereby changing the remote monitoring system from a monitoring status condition to a heightened alert condition.

9. The fixed residential fire suppression system of claim 1, further comprising a locking device capable of remote actuation operably connected to a door of the cabinet housing and having a locked condition and an unlocked condition and also operably connected to a fire detection system having a heightened alert condition and a monitoring status condition, wherein the door of the cabinet housing is disposed in the locked condition in the monitoring status condition, and wherein heightened alert condition of the fire detection system initiates a signal that is received by the locking device and causes the locking device to release thereby causing the unlocked condition.

10. The fixed residential fire suppression system of claim 9, further comprising a local override device operably connected to the locking device wherein activation of the local override device initiates a signal to the locking device and causes the locking device to release and the door of the cabinet housing to allow access.

11. The fixed residential fire suppression system of claim 9, further comprising a fail safe device, wherein the locking device comprises an electromechanical device wherein lack of electrical power to the residential fire suppression system causes the locking device to actuate to the unlocked position.

12. The fixed residential fire suppression system of claim 1, further comprising a flow switch operably connected to the residential water supply and having an open position and a closed position and also operably connected to a fire detection system having a heightened alert condition and a monitoring status condition, wherein the flow switch is disposed in the closed position in the monitoring status condition, and wherein disposition of the flow switch in the open position initiates a signal adapted for reception by the fire detection system to cause it to change to the heightened alert condition.

13. The fixed residential fire suppression system of claim 1, wherein the foam cartridge emits class-A fire suppression foam.

14. The fixed residential fire suppression system of claim 1, wherein the foam nozzle comprises an air inducting foam nozzle having a smooth inner bore and about one-half the diameter as a diameter of the fire resistant hose.

15. The fixed residential fire suppression system of claim 1, wherein the foam applicator unit further comprises a quick release cap disposed over the foam nozzle to prevent drying of the foam applicator unit during storage and infiltration of contaminants and that detaches under water pressure resulting from a fluid discharge of the foam nozzle.

16. A fixed residential fire suppression system comprising a cabinet housing having a drop down door and configured to be permanently mounted in a wall, wherein the heat resistant hose comprises a flat lying hose comprised of an extruded elastomeric material and having a diameter of 0.75 inch and situated on the drop down door of the cabinet in a folded configuration and removably secured thereon by a quick-releasing mechanical fastener, a manual whistle situated in the cabinet housing, and a manual discharge fire suppression foam delivery system situated in the cabinet housing and comprising a fire suppression foam applicator unit, a foam nozzle and a means for connection to residential water supply, wherein the heat resistant hose is operably connected to the means for connection to the residential plumbing system, wherein the foam applicator unit is operably connected to and situated between the heat resistant flat lying hose and the foam nozzle, wherein the foam nozzle emits in combination water from the residential water supply and a fire suppression foam concentrate from the foam applicator unit.

17. The fixed residential fire suppression system of claim 16, wherein the water supply comprises a standpipe adapted for connection to a residential plumbing system and having a one quarter turn valve.

18. The fixed residential fire suppression system of claim 16, wherein the mechanical fastener is a strap harness having a hook and loop mechanical fastener.

19. A fixed residential fire suppression system comprising a cabinet housing having a drop down door and configured to be permanently mounted in a wall, a heat resistant hose having a diameter of 0.75 inch that is situated on the drop down door of the cabinet in a folded configuration and removably secured therein by a quick-releasing mechanical fastener, and a manual discharge fire suppression foam delivery system situated in the cabinet housing and comprising a fire suppression foam applicator unit, an air inducting foam nozzle having a discharge tip with a smooth inner bore, and a means for connection to a residential plumbing system and having a one quarter turn valve wherein the heat resistant hose is operably connected to the means for connection to the residential plumbing system and the foam applicator unit is operably connected to and situated between the heat resistant flat lying hose and the foam nozzle.

20. The fixed residential fire suppression system of claim 19, wherein the foam nozzle emits in combination water from the residential plumbing system, air and a fire suppression foam concentrate from the foam applicator unit having a foam concentrate selected from the group consisting of a protein based fire suppression foam concentrate, an aqueous film forming fire suppression foam concentrate, an alcohol resistant aqueous film forming fire suppression foam concentrate, and combinations thereof.
